(19) United States
(12) Patent Application Publication
(10) Pub. No.: US 2025/0326892 A1
(43) Pub. Date: Oct. 23, 2025

(54) TRIPTYCENE-PHENANTHROLINE BASED MICROPOROUS POLYMER FOR CO2 CAPTURE OVER CH4 AND N2

(71) Applicant: KING FAHD UNIVERSITY OF PETROLEUM AND MINERALS, Dhahran (SA)

(72) Inventors: Mohd Yusuf KHAN, Dhahran (SA); Mosim ANSARI, Dhahran (SA)

(73) Assignee: KING FAHD UNIVERSITY OF PETROLEUM AND MINERALS, Dhahran (SA)

(21) Appl. No.: 18/639,477

(22) Filed: Apr. 18, 2024

(51) Int. Cl. C08G 73/06; B01D 53/04; C08J 9/12

(52) U.S. Cl. CPC C08G 73/0688; B01D 53/04; C08J 9/125; B01D 2253/202; B01D 2253/304; B01D 2253/306; B01D 2253/311; B01D 2256/10; B01D 2256/245; B01D 2257/504; C08J 2379/04

(57) ABSTRACT

A microporous polymer material that includes reacted units of a triptycene compound and a phenanthroline compound in the form of a contorted polymeric structure. A molar ratio of the triptycene compound to the phenanthroline compound is in a range of 1:1 to 1:4. The triptycene compound is covalently bonded to the phenanthroline compound in the formation of the microporous polymer material.

### BACKGROUND

### Technical Field

The present disclosure is directed to a triptycene-phenanthroline-based microporous polymer, specifically a triptycene-phenanthroline-based microporous polymer for effective CO₂ capture over CH₄ and N₂.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Increasing concentration of carbon dioxide (CO₂) in the atmosphere is the primary cause of global warming and its consequences such as climate change. The latest statistics from 2023 show that the atmospheric CO₂ content is higher than it has ever been in modern history, topping 420 parts per million (ppm) and continuing to rise. This corresponds to an approximate 50% rise since the start of the industrial age and an upsurge of around 14% since the year 2000 when the CO₂ concentration was already quite near 370 ppm. CO₂ capture and separation are considered one of the effective ways to reduce the amount of CO₂ in the atmosphere. The wet scrubbing method in industries uses monoethanolamine (MEA) for the chemisorption of CO₂. However, there are serious drawbacks associated with this process such as very high energy of regeneration, corrosion of equipment due to the corrosive nature of MEA, and low capture capacity. The use of porous solid adsorbents for CO₂ capture is an efficient alternative approach. In contemporary research, the development of porous materials for efficient CO₂ uptake is of great importance. Various porous materials have been explored for this purpose such as zeolites-based [See: S. Kumar, R. Srivastava, J. Koh, Utilization of zeolites as CO₂ capturing agents: Advances and future perspectives, Journal of CO₂ Utilization. 41 (2020) 101251.], porous carbons [See: X. Yuan, J. Wang, S. Deng, M. Suvarna, X. Wang, W. Zhang, S. T. Hamilton, A. Alahmed, A. Jamal, A. H. A. Park, X. Bi, Y. S. Ok, Recent advancements in sustainable upcycling of solid waste into porous carbons for carbon dioxide capture, Renewable and Sustainable Energy Reviews. 162 (2022). https://doi.org/10.1016/j.rser.2022.112413.], metal-organic frameworks (MOFs) [See: S. Mahajan, M. Lahtinen, Recent progress in metal-organic frameworks (MOFs) for CO₂ capture at different pressures, J Environ Chem Eng. 10 (2022).], and others [See: G. Singh, J. Lee, A. Karakoti, R. Bahadur, J. Yi, D. Zhao, K. Albahily, A. Vinu, Emerging trends in porous materials for CO₂ capture and conversion, Chem Soc Rev. 49 (2020).]. However, as time required, a new class of porous materials called porous organic polymers, which have a significant specific surface area and a persistent pore structure, emerged for this purpose. Because of their high porosity, design flexibility, huge specific surface area, low density, and superior physiochemical stability, POPs have tremendous potential for usage in a variety of processes such as energy storage, catalysis, and gas capture and separation. Moreover, the synthesis of porous organic polymers is also relatively facile compared to that of inorganic microporous materials and metal-organic frameworks (MOFs).

Although several materials have been developed in the past for CO₂ capture, there still exists a need to fabricate and explore more efficient POPs-based materials for efficient and selective CO₂ capture.

### SUMMARY

In an exemplary embodiment, a microporous polymer material is described. The microporous polymer material includes reacted units of a triptycene compound, and a phenanthroline compound in the form of a contorted polymeric structure. A molar ratio of the triptycene compound to the phenanthroline compound is in a range of 1:1 to 1:4. The triptycene compound is covalently bonded to the phenanthroline compound in the formation of the microporous polymer material.

In some embodiments, the triptycene compound has a formula (I):

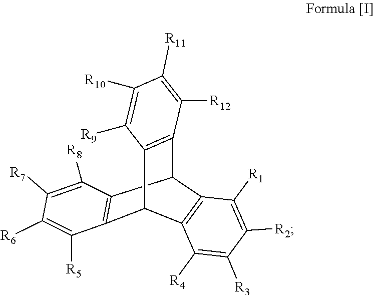

R₁ to R₁₂ are each independently selected from the group consisting of a hydrogen atom, a halogen atom, an optionally substituted alkyl, an optionally substituted aryl, and an optionally substituted heterocyclic aryl.

In some embodiments, the triptycene compound is 9,10-Dihydro-9,10-[1,2]benzenoanthracene.

In some embodiments, the phenanthroline compound has a formula (II):

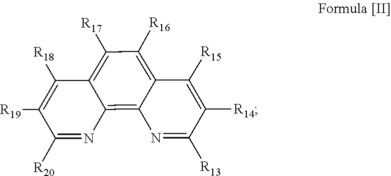

R₁₃ and R₂₀ are each independently a halogen atom. R₁₄ to R₁₉ are each independently selected from the group consisting of a hydrogen atom, a halogen atom, an optionally substituted alkyl, an optionally substituted aryl, and an optionally substituted heterocyclic aryl.

In some embodiments, the phenanthroline compound is 2,9-dichloro-1,10-phenanthroline.

In some embodiments, the reacted units have a formula (III):

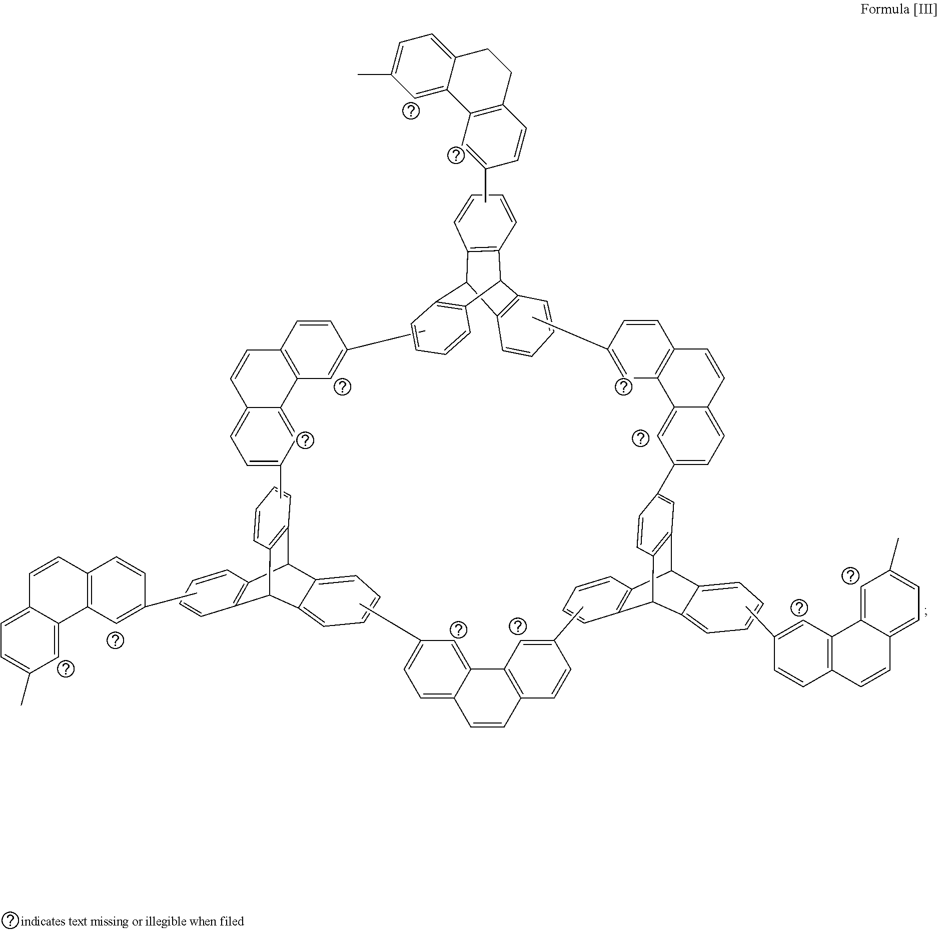

[symbol] is an adjacent contorted polymeric structure.

In some embodiments, particles of the microporous polymer material are in the form of microspheres having an average diameter in a range of 0.5 to 1 micrometer (μm).

In some embodiments, the microspheres are aggregated.

In some embodiments, the microporous polymer material has a Brunauer-Emmett-Teller (BET) surface area of 1100 to 1200 square meter per gram (m²/g).

In some embodiments, the microporous polymer material has a total pore volume (Vₜₒₜ) of 0.6 to 0.7 cubic centimeters per gram (cm³/g).

In some embodiments, the microporous polymer material has a micropore volume (V_{mic}) of 0.4 to 0.5 cm³/g.

In some embodiments, the microporous polymer material has a carbon dioxide (CO₂) isosteric heat of adsorption (Qₛₜ) of 20 to 30 kilojoules per mole (KJ/mol).

In some embodiments, the microporous polymer material has a CO₂ uptake of about 2.5 to 3 millimoles per gram (mmol/g) of the microporous polymer material at about 273 K and 1 bar.

In some embodiments, the microporous polymer material has a CO₂ uptake of about 1.5 to 2.3 mmol/g at about 298 K and 1 bar.

In some embodiments, the microporous polymer material has a thermal degradation temperature of 350 to 420° C. The thermal degradation temperature is determined at a weight loss of 10 percent by weight based on an initial weight of the microporous polymer material.

In another exemplary embodiment, a method for capturing carbon dioxide directly from a CO₂-containing gaseous composition is described. The method includes contacting and passing the CO₂-containing gaseous composition through particles of the microporous polymer material, thereby adsorbing at least a portion of CO₂ from the CO₂-containing gaseous composition onto surfaces of the microporous polymer material particles and forming a purified gas composition.

In some embodiments, the CO₂ is present in the CO₂-containing gaseous composition in an amount of 5 to 60 vol. % based on a total volume of the CO₂-containing gaseous composition.

In some embodiments, the CO₂-containing gaseous composition includes CO₂ and N₂. The microporous polymer material has a Henry's Law selectivity for CO₂ over N₂ of about 20 to 27.8 at 270-300 K and 1 bar.

In some embodiments, the CO₂-containing gaseous composition includes CO₂ and CH₄. The microporous polymer material has a Henry's Law selectivity for CO₂ over CH₄ of about 3.8 to 5.8 at 270-300 K and 1 bar.

In some embodiments, the method includes further includes preparing the microporous polymer material by mixing a triptycene compound, a phenanthroline compound, and an aluminum salt in an organic solvent to form a mixture. A molar ratio of the triptycene compound to the phenanthroline compound is in a range of 1:1 to 1:2. A molar ratio of the triptycene compound to the aluminum salt is in a range of 1:2 to 1:8; by heating and refluxing the mixture to form the microporous polymer material in the mixture; by separating the microporous polymer material from the mixture by filtering, washing, and drying.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof may be readily obtained as the same becomes better understood by reference to the following detailed description when considered in connection with the accompanying drawings, wherein:

FIG. 1A is a flow chart depicting a method for preparing the microporous polymer material, according to certain embodiments.

FIG. 1B is a schematic representation for the synthesis of 3D-triptycene and phenanthroline-based microporous polymer (TPPM), according to certain embodiments.

FIG. 2A shows a Fourier-transform infrared (FTIR) spectra of the TPPM, according to certain embodiments.

FIG. 2B shows a ¹³C Cross-Polarization Magic-Angle-Spinning Nuclear magnetic resonance (¹³C CP/MAS NMR) spectra of the TPPM, according to certain embodiments.

FIG. 3A shows a powder X-ray diffraction (PXRD) pattern of the TPPM, according to certain embodiments.

FIG. 3B shows a thermogravimetric analysis (TGA) analysis of the TPPM, according to certain embodiments.

FIG. 4A is a field-emission scanning electron microscopy (FE-SEM) image of the TPPM at 2 micrometers (μm) magnification, according to certain embodiments.

FIG. 4B is an FE-SEM image of the TPPM at 1 μm magnification, according to certain embodiments.

FIG. 4C is a zoomed-in FE-SEM image of the TPPM at 1 μm magnification, according to certain embodiments.

FIG. 5A is a nitrogen (N₂) sorption isotherm at 77 kelvin (K) for the TPPM, according to certain embodiments.

FIG. 5B is a pore size distribution plot for the TPPM, according to certain embodiments.

FIG. 6A shows CO₂ adsorption-desorption isotherms of the TPPM at various temperatures, according to certain embodiments.

FIG. 6B shows heat of adsorption of the TPPM, according to certain embodiments.

FIG. 7A shows CO₂, CH₄, and N₂ experimental single-component adsorption isotherms of TPPM at 273 K, according to certain embodiments.

FIG. 7B shows CO₂, CH₄, and N₂ experimental single-component adsorption isotherms of TPPM at 298 K, according to certain embodiments.

FIG. 8A shows initial gas uptake slopes of CO₂, N₂ and CH₄ at 273 K for TPPM, according to certain embodiments.

FIG. 8B shows initial gas uptake slopes of CO₂, N₂ and CH₄ at 298 K for TPPM, according to certain embodiments.

FIG. 9 shows BET plot of TPPM, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the words “a” and “an” and the like carry the meaning of “one or more”. Within the description of this disclosure, where a numerical limit or range is stated, the endpoints are included unless stated otherwise. Also, all values and subranges within a numerical limit or range are specifically included as if explicitly written out.

As used herein, the term ‘substituted’ refers to at least one hydrogen atom that is replaced with a non-hydrogen group, provided that normal valencies are maintained and that the substitution results in a stable compound. When a group is noted as “optionally substituted”, the group may or may not contain non-hydrogen substituents. When present, the substituent(s) may be selected from alkyl, halo (e.g., chloro, bromo, iodo, fluoro), hydroxyl, alkoxy, oxo, alkanoyl, aryloxy, alkanoyloxy, amino (—NH₂), alkylamino (—NHalkyl), cycloalkylamino (—NHcycloalkyl), arylamino (—NHaryl), arylalkylamino (—NHarylalkyl), disubstituted amino (e.g., in which the two amino substituents are selected from alkyl, aryl or arylalkyl, including substituted variants thereof, with specific mention being made to dimethylamino), alkanoylamino, aroylamino, arylalkanoylamino, thiol, alkylthio, arylthio, arylalkylthio, alkylthiono, arylthiono, arylalkylthiono, alkylsulfonyl, arylsulfonyl, arylalkylsulfonyl, sulfonamide (e.g., —SO₂NH₂), substituted sulfonamide (e.g., —SO₂NHalkyl, —SO₂NHaryl, —SO₂NHarylalkyl, or cases where there are two substituents on one nitrogen selected from alkyl, aryl, or alkylalkyl), nitro, cyano, carboxy, unsubstituted amide (i.e. —CONH₂), substituted amide (e.g., —CONHalkyl, —CONHaryl, —CONHarylalkyl or cases where there are two substituents on one nitrogen selected from alkyl, aryl, or alkylalkyl), alkoxycarbonyl, aryl, guanidine, heterocyclyl (e.g., pyridyl, furyl, morpholinyl, pyrrolidinyl, piperazinyl, indolyl, imidazolyl, thienyl, thiazolyl, pyrrolidyl, pyrimidyl, piperidinyl, homopiperazinyl), and mixtures thereof. The substituents may themselves be optionally substituted and may be either unprotected, or protected as necessary, as known to those skilled in the art.

As used herein, the term “alkyl” unless otherwise specified refers to both branched and straight chain aliphatic (non-aromatic) hydrocarbons which may be primary, secondary, and/or tertiary hydrocarbons typically having 1 to 32 carbon atoms (e.g., C₁, C₂, C₃, C₄, C₅, C₆, C₇, C₈, C₉, C₁₀, C₁₁, C₁₂, C₁₃, C₁₄, etc.) and specifically includes, but is not limited to, saturated alkyl groups such as methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl, 2-ethylhexyl, heptyl, octyl, nonyl, 3,7-dimethyloctyl, decyl, undecyl, dodecyl, tridecyl, tetradecyl, pentadecyl, hexadecyl, heptadecyl, octadecyl, nonadecyl, eicosyl, guerbet-type alkyl groups (e.g., 2-methylpentyl, 2-ethylhexyl, 2-proylheptyl, 2-butyloctyl, 2-pentylnonyl, 2-hexyldecyl, 2-heptylundecyl, 2-octyldodecyl, 2-nonyltridecyl, 2-decyltetradecyl, and 2-undecylpentadecyl), as well as unsaturated alkenyl and alkynyl variants such as vinyl, allyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, oleyl, linoleyl, and the like.

As used herein, the term “porosity” refers to a measure of the void or vacant spaces within a material.

As used herein, the term “pore size” may be thought of as the lengths or longest dimensions of a particle and of a pore opening.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

The present disclosure is intended to include all isotopes of a given compound or formula, unless otherwise noted.

As used herein, the term ‘optionally substituted alkyl’ refers to the alkyl group which is substituted with one, two, or three substituents independently selected from hydroxyl, alkoxy, carboxy, cyano, alkoxycarbonyl, alkylthio, alkylsulfonyl, halo, haloalkoxy, —CONRR′ or —NRR′ (where each R is hydrogen, alkyl, hydroxyalkyl, or alkoxyalkyl, and each R′ is hydrogen, alkyl) or heterocyclic (preferably heterocycloamino) optionally substituted with one or two groups independently selected from alkyl, hydroxyl, alkoxy, alkylsulfonyl, halo, or —CONRR′ where R and R′ are as defined above.

Aspects of the present disclosure are directed towards a novel 3D-triptycene and phenanthroline-based polymer (TPPM) that forms a porous material. The polymer has microporosity in the form of its cyclical structure. Polar functional groups are used in a simple approach for efficient carbon dioxide capture. The polymeric framework of TPPM is incorporated with 3D triptycene and phenanthroline as robust motifs to yield preferably inflexible, twisted polymeric frameworks with an abundance of micropores and ultra-micropores-conferring higher surface area, abundant microporosity, and physiochemical and thermal stability.

The present disclosure describes the synthesis, characterization, and CO₂ capture studies of the novel TPPM. The polymeric framework of TPPM is incorporated with 3D triptycene and phenanthroline as robust motifs to yield inflexible, twisted polymeric frameworks with an abundance of micropores and ultra-micropores. This confers desirable features such as higher surface area, abundance microporosity, and physiochemical and thermal stability. TPPM demonstrated excellent thermal stability (T_{d}>380° C.) with a larger Brunauer-Emmett-Teller (BET)-specific surface area of 1120 square meters per gram (m²g⁻¹), and considerable microporosity which makes it a promising adsorbent for CO₂ capture applications. The morphological characterization of the polymer sample shows the formation of microspheres with diameters around 0.5 to 1 micrometer (μm). TPPM has a strong affinity for CO₂ with Qₛₜ of 23 kilojoules per mole (KJ mol⁻¹) demonstrating promising CO₂ capture capacity of 2.76 millimoles per gram (mmol g⁻¹) at 273 K and 1.85 mmol g⁻¹ at 298 K where the micropore volume (V_{mic}=0.445 centimeters per gram (cm³ g⁻¹)) plays a potential role. TPPM also demonstrated promising CO₂ selectivity over CH₄ and N₂, showing good promise for CO₂ adsorption and separation.

In an exemplary embodiment, a microporous polymer and corresponding polymer material is described. The microporous polymer and polymer material include reacted units of a triptycene compound and a phenanthroline compound in the form of a contorted polymeric structure. Triptycene is a unique molecular unit with three blades, each composed of a benzene ring. Its rigid, three-dimensional framework makes it an intriguing building block for various applications. Triptycene is a distinctive three-dimensional molecule having three arene rings oriented in a paddle wheel fashion. Internal free volume (IFV) and excellent thermal stability are known characteristics of its unique rigid and sturdy structure.

In some embodiments, the triptycene compound has a formula (I):

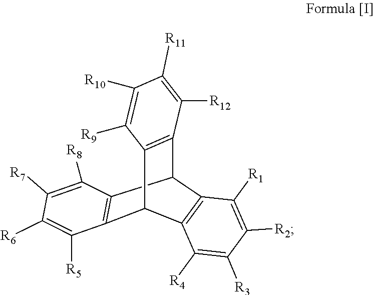

R₁ to R₁₂ are each independently selected from the group consisting of a hydrogen atom, a halogen atom, an optionally substituted alkyl, an optionally substituted aryl, and an optionally substituted heterocyclic aryl. In some embodiments, the triptycene compound is 9,10-dihydro-9,10-[1,2]benzenoanthracene. In some embodiments, the phenanthroline compound has a formula (II):

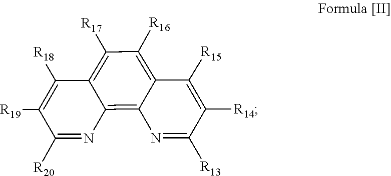

R₁₃ and R₂₀ are each independently a halogen atom. R₁₄ to R₁₉ are each independently selected from the group consisting of a hydrogen atom, a halogen atom, an optionally substituted alkyl, an optionally substituted aryl, and an optionally substituted heterocyclic aryl. In some embodiments, the phenanthroline compound is 2,9-dichloro-1,10-phenanthroline. The molar ratio of the triptycene compound to the phenanthroline compound is in a range of 1:1 to 1:4, more preferably 0.68. The triptycene compound is covalently bonded to the phenanthroline compound in the formation of the microporous polymer material.

In some embodiments, the reacted units have a formula (III):

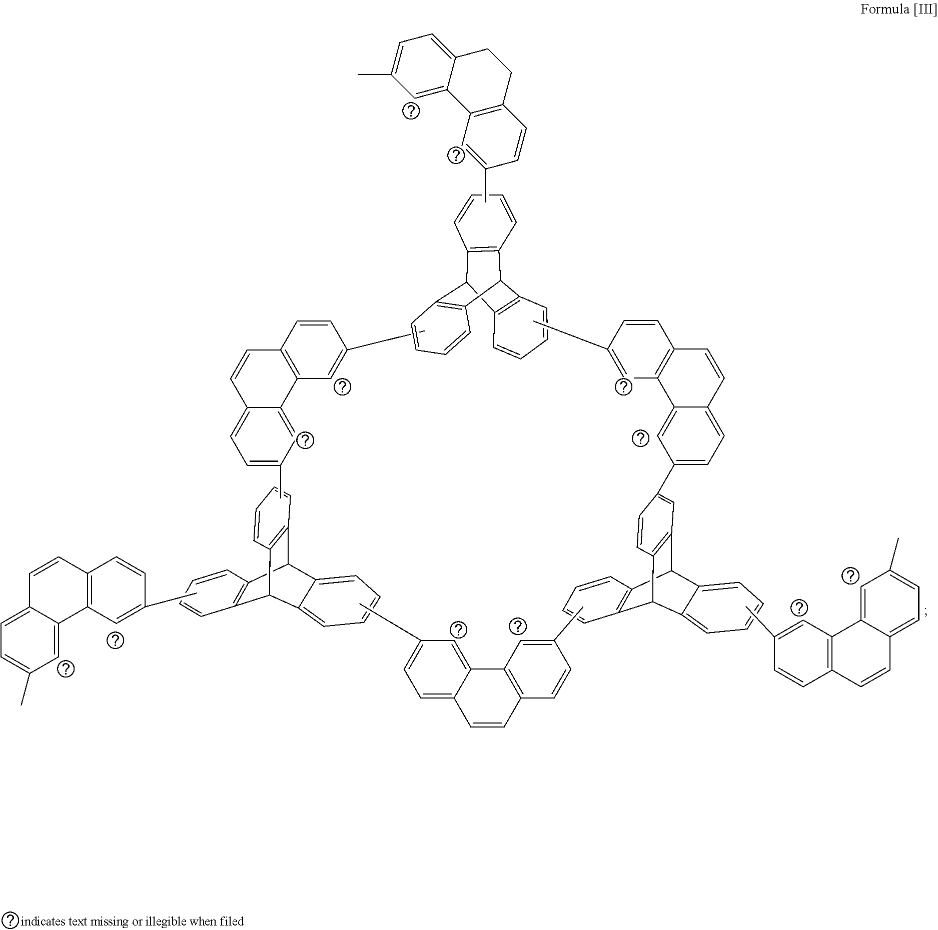

[symbol] is an adjacent contorted polymeric structure.

In some embodiments, particles of the microporous polymer material are in the form of microspheres having an average diameter in a range of 0.5 to 1 micrometer (μm). The particles may exist in various morphological shapes, such as rods, spheres, wires, crystals, rectangles, triangles, pentagons, hexagons, prisms, disks, cubes, ribbons, blocks, beads, toroids, discs, barrels, granules, whiskers, flakes, foils, powders, boxes, stars, tetrapods, belts, flowers, etc. and mixtures thereof. In some embodiments, the microspheres are aggregated. The polymer material and corresponding microspheres may also have micro-and/or macro-porosity.

In some embodiments, the microporous polymer TPPM is in the form of porous particles. Pores in porous particles may be micropores, mesopores, macropores, and/or a combination thereof. In a preferred embodiment, porous particles have micropores. In some embodiments, the microporous polymer material has a BET surface area of 1100 to 1200 m²/g, more preferably 1110 to 1130 m²/g, and yet more preferably 1120 m²/g. In some embodiments, the microporous polymer material has a total pore volume (Vₜₒₜ) of 0.6 to 0.7 cm³/g, more preferably 0.635 to 0.660 cm³/g, and yet more preferably 0.650 cm³/g. In some embodiments, the microporous polymer material has a micropore volume (V_{mic}) of 0.4 to 0.5 cm³/g, more preferably 0.440 to 0.450 cm³/g, and yet more preferably 0.445 cm³/g. In some embodiments, the microporous polymer material has a carbon dioxide (CO₂) isosteric heat of adsorption (Qₛₜ) of 20 to 30 KJ/mol, more preferably 22 to 24 KJ/mol, and yet more preferably 23 KJ/mol. In some embodiments, the microporous polymer material has a CO₂ uptake of about 2.5 to 3 mmol/g, more preferably 2.5 to 2.8 mmol/g, and yet more preferably mmol/g of the microporous polymer material at about 273 K and 1 bar. In some embodiments, the microporous polymer material has a CO₂ uptake of about 1.5 to 2.3 mmol/g, more preferably 1.80 to 1.90 mmol/g, and yet more preferably 1.85 mmol/g at about 298 K and 1 bar. In some embodiments, the microporous polymer material has a thermal degradation temperature of 350 to 420° C., more preferably 380 to 385° C., and yet more preferably 382° C. The thermal degradation temperature is determined at a weight loss of 10 percent by weight based on the initial weight of the microporous polymer material.

In some embodiments, a method for capturing carbon dioxide directly from a CO₂-containing gaseous composition is described. The method includes contacting and passing the CO₂-containing gaseous composition through particles of the microporous polymer material, thereby adsorbing at least a portion of CO₂ from the CO₂-containing gaseous composition onto surfaces and/or into the pores of the microporous polymer material particles and forming a purified gas composition. In some embodiments, the CO₂ is present in the CO₂-containing gaseous composition in an amount of 5 to 60 vol. % based on the total volume of the CO₂-containing gaseous composition. In some embodiments, the CO₂-containing gaseous composition includes CO₂ and N₂. The microporous polymer material has a Henry's Law selectivity for CO₂ over N₂ of 18 to 30 or about 20 to 27.8 at 270-300 K and 1 bar, preferably 22 to 25 or about 24. In some embodiments, the CO₂-containing gaseous composition includes CO₂ and CH₄. The microporous polymer material has a Henry's Law selectivity for CO₂ over CH₄ of about 3.8 to 5.8 at 270-300 K and 1 bar.

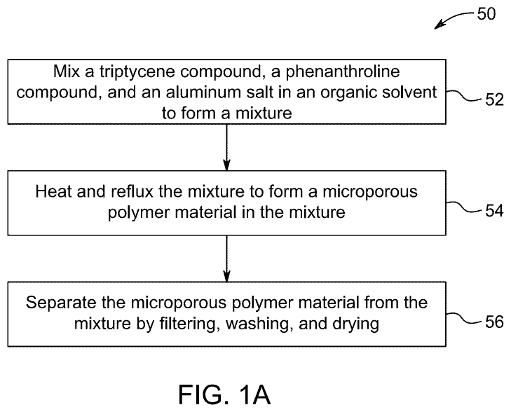

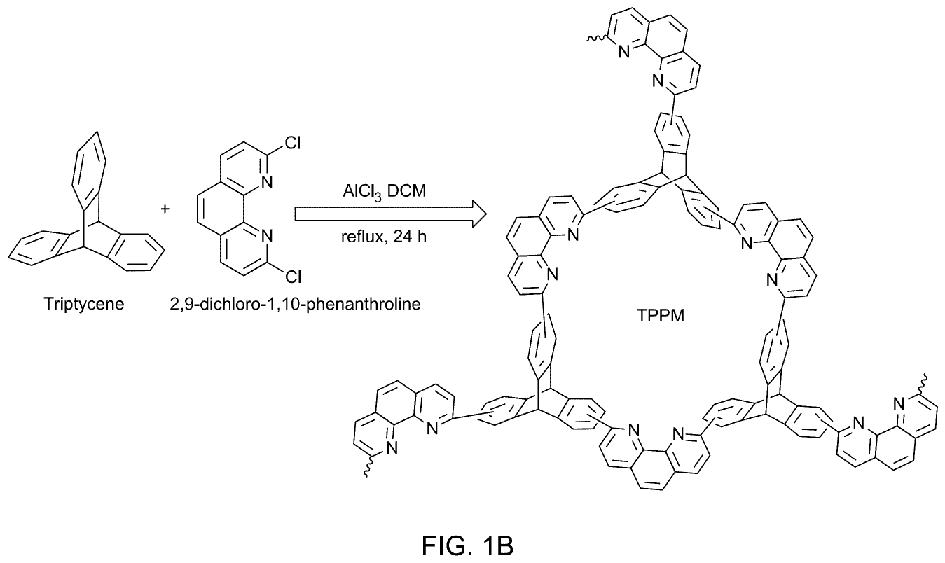

FIG. 1A illustrates a flow chart of a method 50 for preparing the microporous polymer material. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing a triptycene compound, a phenanthroline compound, and an aluminum salt in an organic solvent to form a mixture. In some embodiments, the aluminum salt may include aluminum chloride, aluminum nitrate, and aluminum sulphate. In a preferred embodiment, the aluminum salt is aluminum chloride. In some embodiments, the organic solvent may include tetrahydrofuran, ethyl acetate, dimethylformamide, acetonitrile, acetone, dimethyl sulfoxide, nitromethane, propylene carbonate, ethanol, formic acid, n-butanol, methanol, or any combination thereof. In some embodiments, the organic solvent may include benzene, cyclohexane, ethanol, methanol, acetone, ethyl acetate, dichloromethane, toluene, and diethyl ether. The mixing may be carried out manually or with the help of a stirrer. The molar ratio of the triptycene compound to the phenanthroline compound is in a range of 1:1 to 1:2, more preferably 0.68. The molar ratio of the triptycene compound to the aluminum salt is in a range of 1:2 to 1:8 or 1:4 to 1:6 or more preferably 0.477.

At step 54, the method 50 includes heating and refluxing the mixture to form the microporous polymer material in the mixture. The reflux can be done for 18-30 hours (h), preferably 19-29 h, preferably 20-28 h, preferably 21-27 h, preferably 22-26 h, and preferably 23-25 h, to form a solid. In a preferred embodiment, the mixture is refluxed for 24 hours, preferably with alcohol. The alcohol such as methanol, ethanol, propanol, isopropanol, butanol, pentanol, and hexanol. In a preferred embodiment, the solid is refluxed with methanol.

At step 56, the method 50 includes separating the microporous polymer material from the mixture by filtering, washing, and drying. The filtration can be done by methods used or known in the art. In a preferred embodiment, the filtration is done by glass frit. After filtration, the solid may be washed using a solvent like water, methanol, ethanol, acetone, DMSO, DMF, dimethylacetamide, isopropanol, benzene, hexane, carbon tetrachloride, toluene, diethyl ether, THF, DCM, chloroform, or a mixture thereof. In a preferred embodiment, the solid is washed using DCM, water, methanol, THF, and acetone. After washing, the solid is dried at 120° C. in a vacuum oven for 24 h. In some embodiments, the drying can be performed by using heating appliances such as ovens, microwaves, autoclaves, hot plates, heating mantles, tapes, oil baths, salt baths, sand baths, air baths, hot-tube furnaces, and hot-air guns.

The TPPM prepared by the method of present disclosure demonstrates excellent thermal stability (T_{d}>380° C.) with a larger Brunauer-Emmett-Teller (BET)-specific surface area of 1120 square meters per gram (m²g⁻¹), and considerable microporosity which makes it a promising adsorbent for CO₂ capture applications. The morphological characterization of the polymer sample shows the formation of microspheres with diameters around 0.5 to 1 micrometer (μm). TPPM has a strong affinity for CO₂ with Qₛₜ of 23 kilojoules per mole (KJ mol⁻¹), demonstrating promising CO₂ capture capacity of 2.76 millimoles per gram (mmol g⁻¹) at 273 K and 1.85 mmol g⁻¹ at 298 K where the micropore volume (V_{mic}=0.445 centimeters per gram (cm³ g⁻¹)) plays a potential role. TPPM also demonstrated promising CO₂ selectivity over CH₄ and N₂, showing good promise for CO₂ adsorption and separation.

### EXAMPLES

The following examples demonstrate a microporous polymer material. The examples are provided solely for illustration and are not to be construed as limitations of the present disclosure, as many variations thereof are possible without departing from the spirit and scope of the present disclosure.

### Example 1. Chemicals and Materials

2,9-dichloro-1,10-phenanthroline, triptycene, and AlCl₃ (anhydrous) were purchased from Sigma-Aldrich. Without additional purification, the following substances were utilized after being purchased from Sigma-Aldrich: anhydrous dichloromethane (DCM), hydrochloric acid (37%), methanol (99.6%), acetone (99.5%), dimethyl sulfoxide (DMSO), and tetrahydrofuran (THF, 99.9%).

### Example 2: Synthesis of TPPM

The synthesis of TPPM was carried out as follows: A mixture of triptycene (254 mg, 1 mmol), 2,9-dichloro-1,10-phenanthroline (373.5 mg, 1.5 mmol), and AlCl₃ (532 mg, 4 mmol) was taken in a 100 milliliters (ml) round bottom flask with a three-necked adapter. The flask was purged with nitrogen and then filled with dry DCM (30 mL). This reaction mixture was heated and stirred under reflux for 24 hours. After cooling, the solid polymer was filtered through a glass frit and washed sequentially with DCM, water, methanol, THF, and acetone. The polymer was purified by Soxhlet extraction using a 1:99 (v/v) solution of hydrochloric acid and methanol for 24 h. The brown-colored solid polymer was dried in a vacuum oven at 120° C. for 24 h to obtain TPPM as the desired polymer. Yield: 96%; FT-IR: 3013 (═C—H), 2968-2922 (—C—H), 1692 (—C═N), 1603-1458 (Ar—C═C—), 1370, 1179, 1150, 900, 807, 749 cm⁻¹.

### Example 3: Structural Characterizations

The functional groups of the resultant polymer (TPPM) were characterized by Fourier-transform infrared (FTIR) spectroscopy using a Nicolet 6700 FTIR instrument (Thermo Fisher Scientific, USA). The solid-state ¹³C CP-MAS NMR spectra of TPPM were recorded on a Bruker 400 megahertz (MHz) instrument, operating at 125.65 MHz at room temperature. The morphology of TPPM was observed by FE-SEM on a TESCAN-LYRA-3, Czech Republic) instrument with high resolution. The amorphous nature of TPPM was determined by powder XRD with a Rigaku Miniflex-II diffractometer instrument that had a Cu-Kα anode (λ=0.15416 nanometers (nm)). The thermal stability of TPPM was measured by TGA on a TA Q500 instrument under 10 ml min⁻¹ airflow with a heating rate of 10° C. min⁻¹. The N₂ isotherm data acquired by a Quadrasorb SI instrument (Quantachrome Instruments, US) was used to compute the textural parameters of TPPM, including porosity, surface area, and pore volumes.

### Example 4: Gas Adsorption Experiment

A Quadrasorb SI system (Quantachrome Instruments, US) was utilized to analyze the CO₂, CH₄, and N₂ adsorption isotherms at different temperatures. Approximately 200 milligrams of the sample were pretreated for 12 h at 120° C. under a dynamic vacuum (10⁻⁵ bar) before the isotherm measurements. The isotherm temperatures were maintained to within ±1° C. using a flow bath filled with an equimolar combination of water and ethylene glycol.

### Result and Discussion

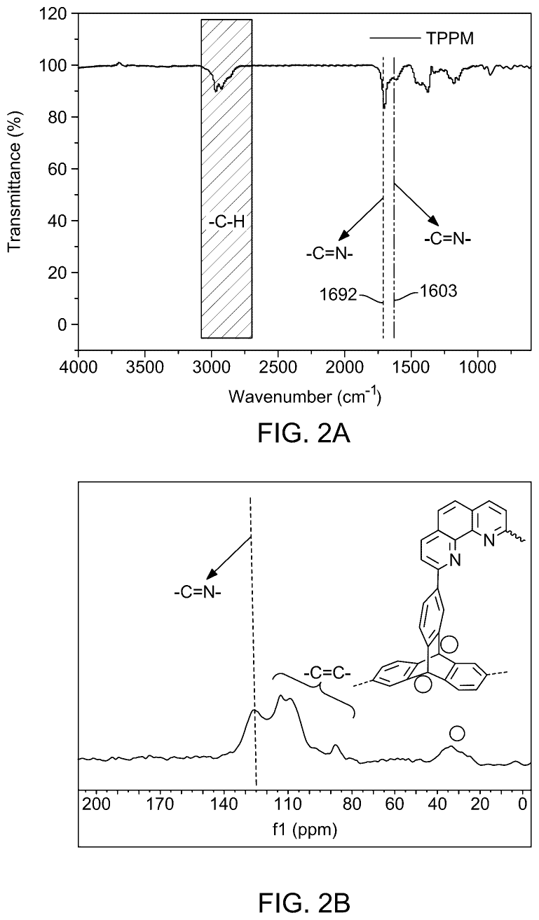

A facile one-pot Friedel-Crafts crosslinking polymerization reaction was used to synthesize the polymer TPPM by using triptycene and 2,9-dichloro-1,10-phenanthroline as monomers (FIG. 1B). TPPM is solid with a brown color and does not dissolve in many common organic solvents, such as DCM, DMSO, DMF, and THF. The solubility test results are shown in Table 1. The ¹³C CP/MAS NMR and FTIR spectroscopy were used for structural characterizations of TPPM. FT-IR spectrum of the polymer TPPM is shown in FIG. 2A. In the FT-IR spectrum of TPPM, the peak due to the existence of —C═N functionality in the polymer appeared at about 1695 cm⁻¹. Additionally, the peak observed at 2960 cm⁻¹ corresponds to the stretching vibration of triptycene bridge head —CH— groups indicating successful crosslinking. The different aromatics —C═C— stretching vibrations peaks appeared in the range of 1603-1458 cm⁻¹.

TABLE 1
Solubility analysis of TPPM in different solvents

| Name of Solvents | TPPM |
|---|---|
| Dichloromethane (DCM) | Insoluble |
| Methanol | Insoluble |
| Tetrahydrofuran (THF) | Insoluble |
| Ethyl acetate | Insoluble |
| Dimethoxy sulfoxide (DMSO) | Insoluble |
| Dimethylacetamide (DMAc) | Insoluble |
| Dimethyl formamide (DMF) | Insoluble |

FIG. 2B shows the ¹³C CP/MAS NMR spectrum of TPPM. As anticipated, the broad peaks in the range of 140-85 parts per million parts per million (ppm) correspond to the aromatic carbons of the polymeric framework. The peak at 129 ppm was assigned to imine-substituted aromatic carbon (C═N). The peaks due to bridgehead carbon of triptycene (—CH—) motifs appeared at about 50-30 ppm. Therefore, ¹³C CP/MAS NMR analysis clearly showed the successfully incorporated 3D-triptycene and phenanthroline units in the polymeric network of TPPM.

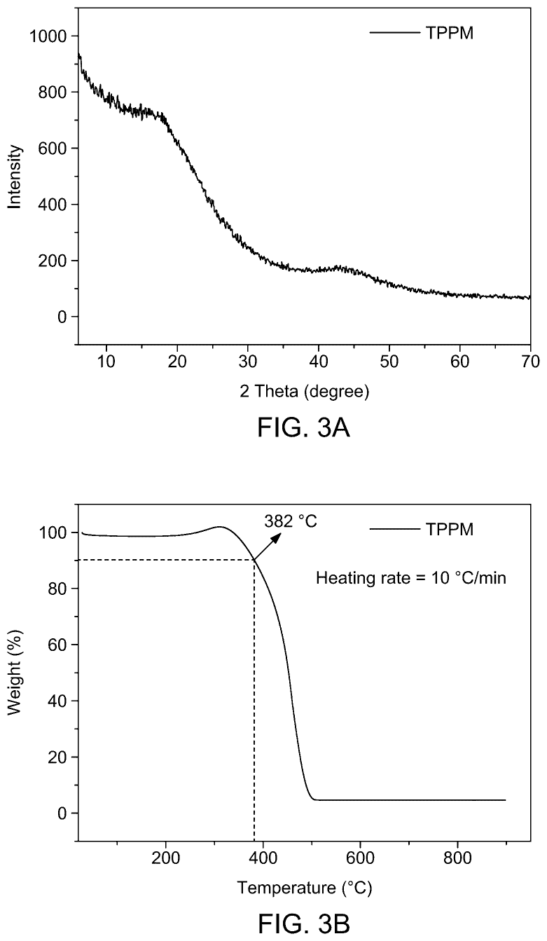

Powder X-ray diffraction (PXRD) analysis of TPPM is displayed in FIG. 3A. The featureless broad spectrum in the PXRD pattern shows that TPPM is amorphous in nature. This may be ascribed to the existence of robust, and bulky triptycene units in the polymeric network of TPPM. The thermal behavior of the TPPM sample was investigated by thermogravimetric analysis (TGA) under airflow, as depicted in FIG. 3B. The sample was placed in an alumina crucible and heated from room temperature to 800° C. at a heating rate of 10° C. The weight loss curve was recorded as a function of temperature.

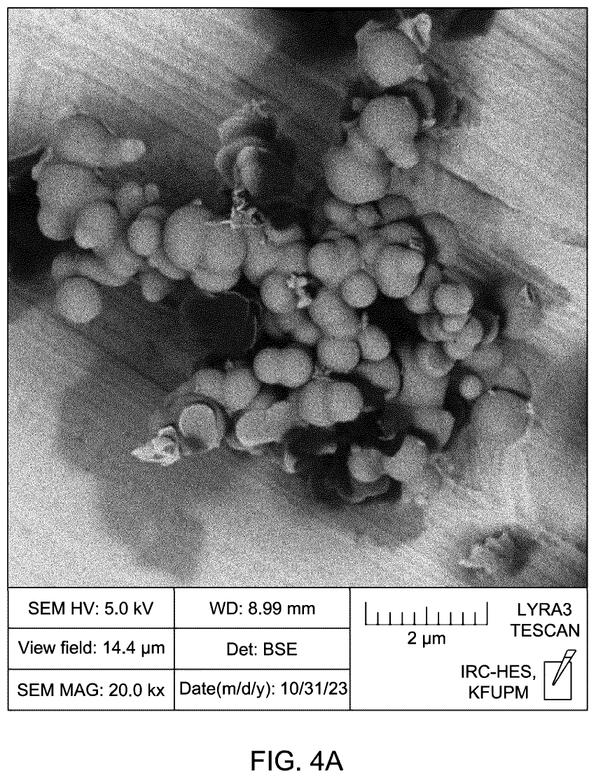

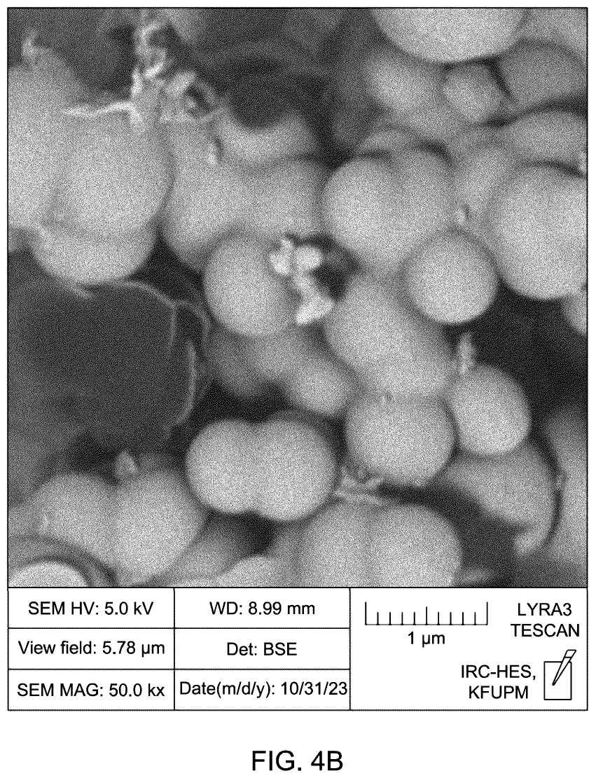

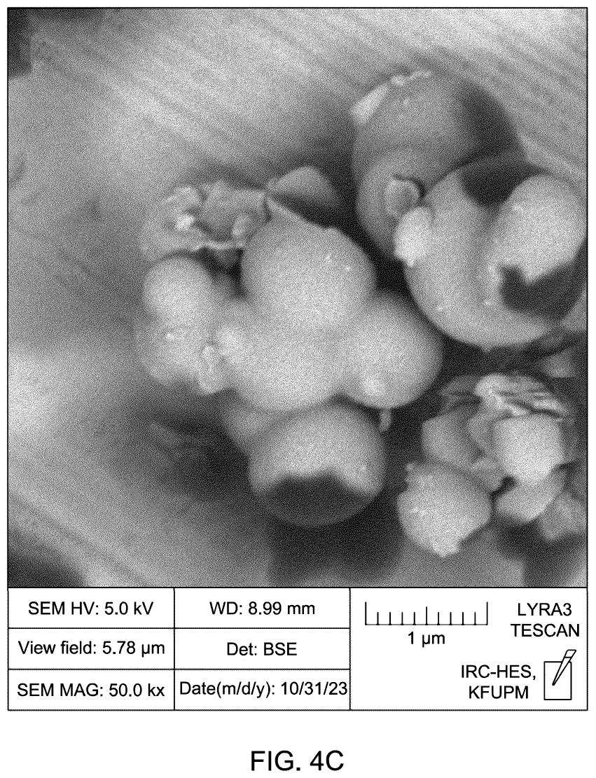

High thermal stability was shown by TPPM, as revealed by its TGA analysis experiment (FIG. 3B). For TPPM, the thermal degradation temperature (T_{d}) was 382° C.; at this point, only 10% weight loss was observed. The existence of stiff robust triptycene units in the polymeric network is attributed to TPPM's excellent thermal stability. The morphology of TPPM was studied further using field-emission scanning electron microscopy (FESEM). As shown in FIGS. 4A-4C, FESEM micrographs of TPPM reveal the formation of microspheres with diameters in the range of 0.5-1 micrometers (μm).

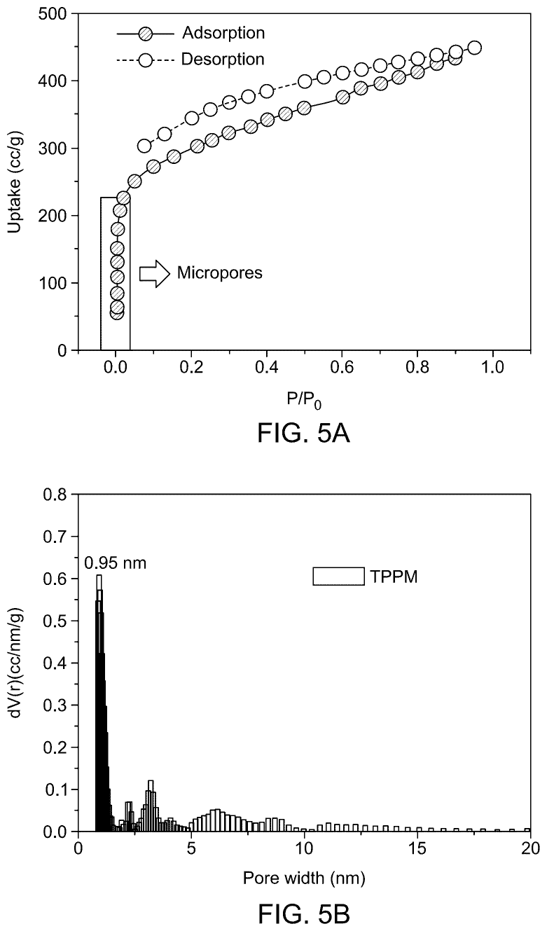

The adsorption and desorption isotherms of N₂ at 77 K and 1 bar pressure were conducted to analyze the textural properties of the samples, such as pore volumes, surface area, and porosity. FIG. 5A illustrates that TPPM exhibited a steep N₂ adsorption at very low-pressure ratios (P/P₀=0-0.01), while the isotherms gradually increased with higher pressure up to 1 bar. This indicates that while some mesopores are present, micropores include the majority of the pores in TPPM.

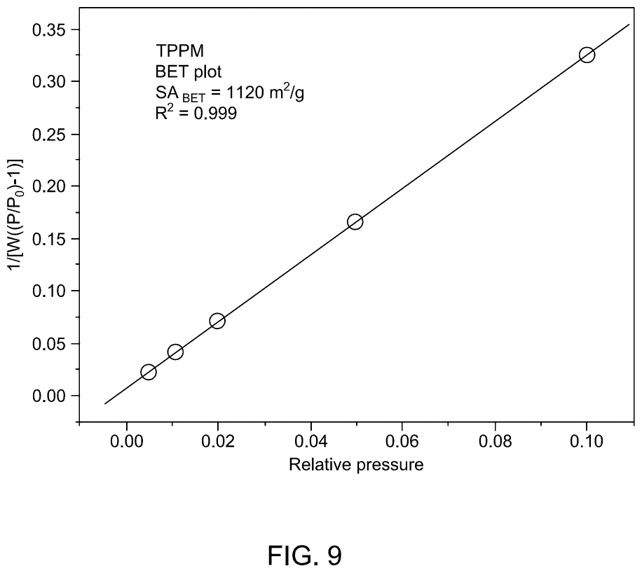

The N₂ sorption isotherm reveals that TPPM has a significant microporosity, with most of the pores having a diameter of 0.95 nm. This is confirmed by the pore size distribution (PSD) plot derived from the DFT method (FIG. 5B). One possible explanation for TPPM's microporous nature is the presence of 3D triptycene units with internal free volumes (IFV) and the rigid concave-shaped phenanthroline producing a contorted polymeric network with microporosity. TPPM revealed a high BET-specific surface area (SA_{BET}) of 1120 meter square per gram (m² g⁻¹) (FIG. 9) with a total pore volume (Vₜₒₜ) of 0.650 cubic centimeters per gram (cm³ g⁻¹) and micropore volume (V_{mic}) of 0.445 cm³ g⁻¹ (Table 2). The measured S_{ABET} of TPPM is found to be greater compared to several porous polymers documented in the literature, including azo-functionalized POPs (TAPs, 474-772 m² g⁻¹) [See: Bera, R.; Ansari, M.; Alam, A.; Das, N. Triptycene, Phenolic-OH, and Azo-Functionalized Porous Organic Polymers: Efficient and Selective CO2 Capture. ACS Appl Polym Mater 2019, 1, 959-968]. Guanidium-based porous network (iCON-5, 53.17 m² g⁻¹) [See: Chandra, S.; Hassan, A.; Prince; Alam, A.; Das, N. Rapid and Efficient Removal of Diverse Anionic Water Contaminants Using a Guanidium-Based Ionic Covalent Organic Network (ICON). ACS Appl Polym Mater 2022, 4, 6630-6641], oxygen-rich HCPs (up to 246.9 m² g⁻¹) [See: Shao, L.; Liu, N.; Wang, L.; Sang, Y.; Wan, H.; Zhan, P.; Zhang, L.; Huang, J.; Chen, J. Facile Preparation of Oxygen-Rich Porous Polymer Microspheres from Lignin-Derived Phenols for Selective CO₂ Adsorption and Iodine Vapor Capture. Chemosphere 2022, 288, 132499], HCTIn hyper crosslinked networks (445-560 m² g⁻¹) [See: Wen, J.; Xiao, L.; Sun, T.; Lei, Z.; Chen, H.; Li, H. Fine Tuning of Specific Surface Area and CO₂ Capture Performance in Hyper-Cross-Linked Heterocyclic Networks with Tetrazinyl Linker. Microporous Mesoporous Mater. 2021, 319, 111069], phenanthroimidazole-based POPs (CPPs, 49-285 m² g⁻¹) [See: Monterde, C.; Navarro, R.; Iglesias, M.; Sánchez, F. Fluorine-Phenanthroimidazole Porous Organic Polymer: Efficient Microwave Synthesis and Photocatalytic Activity. ACS Appl Mater Interfaces 2019, 11, 3459-3465], pyrrolidinone-based HCPs (up to 584 m² g⁻¹) [See: Li, X.; Chen, G.; Ma, J.; Jia, Q. Pyrrolidinone-Based Hypercrosslinked Polymers for Reversible Capture of Radioactive Iodine. Sep Purif Technol 2019, 210, 995-1000], heteroatoms containing POPs (HPOPs, 49-89 m² g⁻¹) [See: Hassan, A.; Das, N. Chemically Stable and Heteroatom Containing Porous Organic Polymers for Efficient Iodine Vapor Capture and Its Storage. ACS Appl Polym Mater 2023, 5, 5349-5359], indone-based POPs (PHOIN_NH2, 509 m² g⁻¹) [See: Xu, Y.; Wang, C.; Yang, L.; Chang, G. Sandwich-like Structure of Indole and Carbon Dioxide with Efficient CO2 Capture and Conversion. ACS Appl Polym Mater 2019, 1, 3389-3395], and triazine-based porous polymers (308-456 m² g⁻¹) [See: Geng, T.; Zhang, W.; Zhu, Z.; Kai, X. Triazine-Based Conjugated Microporous Polymers Constructing Triphenylamine and Its Derivatives with Nitrogen as Core for lodine Adsorption and Fluorescence Sensing I2. Microporous Mesoporous Mater. 2019, 273, 163-170].

TABLE 2
Porous property, adsorption capacity, and value of selectivity
of TPPM measured at various temperatures.

| | | | | CO₂ | CO₂ | Qₛₜ | | |
|---|---|---|---|---|---|---|---|---|
| | | | | uptake at | uptake at | of | Selectivity | Selectivity |
| | SA_{BET} | Vₜₒₜₐₗ | V_{mic} | 273 K | 298 K | CO₂ | CO₂/N₂ | CO₂/CH₄ |
| | (m² | (cm³ | (cm³ | and 1 bar | and 1 bar | (kJ | 273 K | 273 K |
| Material | g⁻¹) | g⁻¹) | g⁻¹) | (mmol/g) | (mmol/g) | mol⁻¹) | (298 K) | (298 K) |
| TPPM | 1120 | 0.65 | 0.445 | 2.76 | 1.85 | 23 | 27.8 (20) | 5.8 (3.8) |

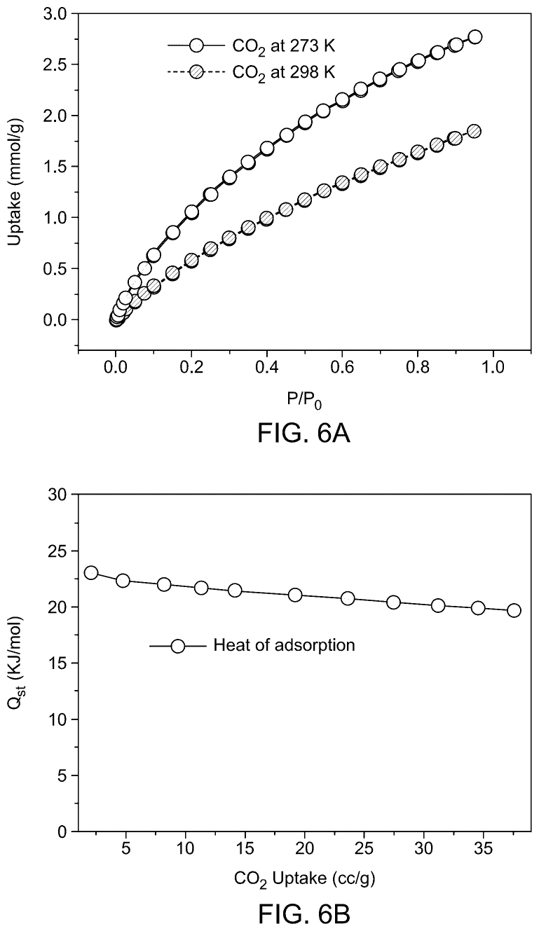

CO₂ uptake isotherms were measured at different temperatures to assess the CO₂ capture capability of TPPM, illustrated in FIG. 6A. The CO₂ adsorption-desorption isotherm reveals the reversible CO₂ uptake ability of TPPM as evident from its hysteresis-free isotherm nature (FIG. 6A). The CO₂ adsorption capacity of TPPM at various temperatures is displayed in Table 2. TPPM can adsorb 2.76 mmol/g of CO₂ at 273 K and 1.85 mmol/g of CO₂ at 298 K. The CO₂ adsorption performance of TPPM at 273K is superior compared to many other porous polymers that have been reported previously for CO₂ adsorption, as displayed in Table 3, a comparison of TPPM's CO₂ uptake performance with other porous polymers reported in the literature. Some representative examples include the capture capabilities of porous polymers based on tetraphenyl anthraquinone (An-CPOPs, 1.40-1.51 mmol/g) [See: Mohamed, M. G.; Zhang, X.; Mansoure, T. H.; El-Mahdy, A. F. M.; Huang, C.-F.; Danko, M.; Xin, Z.; Kuo, S.-W. Hypercrosslinked Porous Organic Polymers Based on Tetraphenylanthraquinone for CO₂ Uptake and High-Performance Supercapacitor. Polymer, 2020, 205, 122857] nitrogen rich Porous polymer (2.22 mmol/g) [See: Cui, Y.; Du, J.; Liu, Y.; Yu, Y.; Wang, S.; Pang, H.; Liang, Z.; Yu, J. Design and Synthesis of a Multifunctional Porous N-Rich Polymer Containing s-Triazine and Tröger's Base for CO2 Adsorption, Catalysis and Sensing. Polym Chem 2018, 9, 2643-2649] triphenylamine- and triphenyl triazine-based-COFs (2.09 mmol/g) [See: El-Mahdy, A. F. M.; Kuo, C. H.; Alshehri, A.; Young, C.; Yamauchi, Y.; Kim, J.; Kuo, S. W. Strategic Design of Triphenylamine- and Triphenyltriazine-Based Two-Dimensional Covalent Organic Frameworks for CO₂ Uptake and Energy Storage. J Mater Chem A 2018, 6, 19532-19541] triazine based covalent imine framework (TPA-TCIF (BD), 1.75 mmol/g)] [See: Puthiaraj, P.; Kim, H. S.; Yu, K.; Ahn, W. S. Triphenylamine-Based Covalent Imine Framework for CO2 Capture and Catalytic Conversion into Cyclic Carbonates. Microporous Mesoporous Mater. 2020, 297, 110011] phthalazinone-based CTFs (PHCTFs, 1.90-2.34 mmol/g) [See: Yuan, K.; Liu, C.; Zong, L.; Yu, G.; Cheng, S.; Wang, J.; Weng, Z.; Jian, X. Promoting and Tuning Porosity of Flexible Ether-Linked Phthalazinone-Based Covalent Triazine Frameworks Utilizing Substitution Effect for Effective CO₂ Capture. ACS Appl Mater Interfaces 2017, 9, 13201-13212] microporous polymer network (6FA-PI-CL, 1.65 mmol/g) [See: Song, N.; Wang, T.; Yao, H.; Ma, T.; Shi, K.; Tian, Y.; Zou, Y.; Zhu, S.; Zhang, Y.; Guan, S. Construction and Carbon Dioxide Capture of Microporous Polymer Networks with High Surface Area Based on Cross-Linkable Linear Polyimides. Polym Chem 2019, 10, 4611-4620] nitro-functionalized porous polymer (PAN-NP, 2.34 mmol/g) [See: Zhang, B.; Yan, J.; Li, G.; Wang, Z. Carboxyl-, Hydroxyl-, and Nitro-Functionalized Porous Polyaminals for Highly Selective CO2 Capture. ACS Appl Polym Mater 2019, 1, 1524-1534] and bicarbazole based porous polymers (CMPs, up to 2.12 mmol/g) [See: Yuan, Y.; Huang, H.; Chen, L.; Chen, Y. N,N′-Bicarbazole: A Versatile Building Block toward the Construction of Conjugated Porous Polymers for CO₂ Capture and Dyes Adsorption. Macromolecules 2017, 50, 4993-5003]. At 298 K, TPPM's CO₂ adsorption capacity is 1.85 mmol/g which is also comparable to or greater than that of several other porous polymers, including POP101-104 (0.92-0.87 mmol/g) [See: Abdelnaby, M. M.; Aliyu, M.; Nemitallah, M. A.; Alloush, A. M.; Mahmoud, E. H. M.; Ossoss, K. M.; Zeama, M.; Dowaidar, M. Design and Synthesis of N-Doped Porous Carbons for the Selective Carbon Dioxide Capture under Humid Flue Gas Conditions. Polymers 2023, 15, 2475] An-CPOPs (1.29-1.40 mmol/g) [See: Mohamed, M. G.; Zhang, X.; Mansoure, T. H.; El-Mahdy, A. F. M.; Huang, C.-F.; Danko, M.; Xin, Z.; Kuo, S.-W. Hypercrosslinked Porous Organic Polymers Based on Tetraphenylanthraquinone for CO₂ Uptake and High-Performance Supercapacitor. Polymer, 2020, 205, 122857], TPT-COF-6 (1.49 mmol/g) [See: El-Mahdy, A. F. M.; Kuo, C. H.; Alshehri, A.; Young, C.; Yamauchi, Y.; Kim, J.; Kuo, S. W. Strategic Design of Triphenylamine- and Triphenyltriazine-Based Two-Dimensional Covalent Organic Frameworks for CO₂ Uptake and Energy Storage. J Mater Chem A 2018, 6, 19532-19541], TPA-TCIF (BD) (1.14 mmol/g) [See: Puthiaraj, P.; Kim, H. S.; Yu, K.; Ahn, W. S. Triphenylamine-Based Covalent Imine Framework for CO₂ Capture and Catalytic Conversion into Cyclic Carbonates. Microporous Mesoporous Mater. 2020, 297, 110011], iCOP (1.5 mmol/g) [Gnani Peer Mohamed, S. I.; Nguyen, T.; Bavarian, M.; Nejati, S. One-Step Synthesis of an Ionic Covalent Organic Polymer for CO₂ Capture. ACS Appl Polym Mater 2022, 4 8021-8025], HCP1 (0.756 mmol/g) [See: Dong, X.; Akram, A.; Comesaña-Gándara, B.; Dong, X.; Ge, Q.; Wang, K.; Sun, S.-P.; Jin, B.; Lau, C. H. Recycling Plastic Waste for Environmental Remediation in Water Purification and CO₂ Capture. ACS Appl Polym Mater 2020, 2, 2586-2593] and CMPs (up to 1.24 mmol/g) [See: Yuan, Y.; Huang, H.; Chen, L.; Chen, Y. N,N′-Bicarbazole: A Versatile Building Block toward the Construction of Conjugated Porous Polymers for CO₂ Capture and Dyes Adsorption. Macromolecules 2017, 50, 4993-5003].

TPPM's promising CO₂ uptake performance may be ascribable to the presence highly microporous network composed of 3D triptycene and phenanthroline. The mechanism of CO₂ adsorption was investigated by calculating the isosteric heat of adsorption (qₛₜ) using isotherms of CO₂ adsorption for TPPM (FIG. 6B). The qₛₜ values provide information about the nature of the interactions between the adsorbent (TPPM) and the adsorbate (CO₂). Given that the magnitude of qₛₜ was found to be 23 KJ mol⁻¹, it indicates that TPPM adsorbed CO₂ via a physisorption mechanism. The measured qₛₜ is comparable to or less than various other heteroatoms with porous organic polymers that have been described in the literature such as TF-PI-CL (28.6-30.2 KJ mol⁻¹) [See: Song, N.; Wang, T.; Yao, H.; Ma, T.; Shi, K.; Tian, Y.; Zou, Y.; Zhu, S.; Zhang, Y.; Guan, S. Construction and Carbon Dioxide Capture of Microporous Polymer Networks with High Surface Area Based on Cross-Linkable Linear Polyimides. Polym Chem 2019, 10, 4611-4620], melamine-based porous polyamides PTPAs (29.5-34.2 KJ mol⁻¹) [See. Shao, L.; Liu, M.; Sang, Y.; Huang, J. One-Pot Synthesis of Melamine-Based Porous Polyamides for CO₂ Capture. Microporous Mesoporous Mater. 2019, 285. 105-111], TPA-TCIF (BD) (33.7 KJ mol⁻¹) [See: Puthiaraj, P.; Kim, H. S.; Yu, K.; Ahn, W. S. Triphenylamine-Based Covalent Imine Framework for CO₂ Capture and Catalytic Conversion into Cyclic Carbonates. Microporous Mesoporous Mater. 2020, 297, 110011], nanoporous frameworks consisting 1,3,5-triazine (NOPs, 29.2-34.1 KJ mol⁻¹) [See: Xiong, S.; Fu, X.; Xiang, L.; Yu, G.; Guan, J.; Wang, Z.; Du, Y.; Xiong, X.; Pan, C. Liquid Acid-Catalysed Fabrication of Nanoporous 1,3,5-Triazine Frameworks with Efficient and Selective CO2 Uptake. Polym Chem 2014, 5, 3424-3431], imine-based porous network polymer PIN1-2 (30 KJ mol⁻¹) [See. Popp, N.; Homburg, T.; Stock, N.; Senker, J. Porous Imine-Based Networks with Protonated Imine Linkages for Carbon Dioxide Separation from Mixtures with Nitrogen and Methane. J Mater Chem A 2015, 3, 18492-18504] and HBPI-CLs (29.1-32.8 KJ mol⁻¹) [See: Popp, N.; Homburg, T.; Stock, N.; Senker, J. Porous Imine-Based Networks with Protonated Imine Linkages for Carbon Dioxide Separation from Mixtures with Nitrogen and Methane. J Mater Chem A 2015, 3, 18492-1850].

TABLE 3
Comparison of CO₂ uptake of TPPM with other reported porous polymers

| | CO₂ | CO₂ | | | | |
|---|---|---|---|---|---|---|
| | uptake at | uptake at | Heat of | CO₂/N₂ | CO₂/CH₄ | |
| | 1 bar | 1 bar | adsorption | Selectivity | Selectivity | |
| | (mmol/g) | (mmol/g) | (Qₛₜ) | 273 K | 273 K | |
| Material | 273 K | 298 K | (kJ/mol) | (298 K) | (298 K) | Ref. |
| TPPM | 2.76 | 1.85 | 23 | 27.8 (20) | 5.8 (3.8) | The present disclosure |
| HCP1b | 0.82 | 0.53 | 38.2 | 32.8 | — | Shao, L.; Liu, N.; Wang, L.; |
| | | | | | | Sang, Y.; Wan, H.; Zhan, P.; |
| | | | | | | Zhang, L.; Huang, J.; Chen, |
| | | | | | | J. Facile Preparation of |
| | | | | | | Oxygen-Rich Porous Polymer |
| | | | | | | Microspheres from Lignin- |
| | | | | | | Derived Phenols for Selective |
| | | | | | | CO2 Adsorption and Iodine |
| | | | | | | Vapor Capture. Chemosphere |
| | | | | | | 2022, 288, 132499. |
| An- | 1.39 | 1.29 | — | — | — | Mohamed, M. G.; Zhang, X.; |
| CPOP-1 | | | | | | Mansoure, T. H.; El-Mahdy, |
| | | | | | | A. F. M.; Huang, C.- F.; |
| | | | | | | Danko, M.; Xin, Z.; Kuo, S.-W. |
| | | | | | | Hypercrosslinked Porous |
| | | | | | | Organic Polymers Based on |
| | | | | | | Tetraphenylanthraquinone |
| | | | | | | for CO2 Uptake and High- |
| | | | | | | Performance Supercapacitor. |
| | | | | | | Polymer, 2020, 205, 122857. |
| PAF-32 | 1.66 | 0.9 | 26 | — | — | Jing, X.; Zou, D.; Cui, P.; |
| | | | | | | Ren, H.; Zhu, G. Facile |
| | | | | | | Synthesis of Cost-Effective |
| | | | | | | Porous Aromatic Materials |
| | | | | | | with Enhanced Carbon |
| | | | | | | Dioxide Uptake. J Mater |
| | | | | | | Chem A 2013, 1, 13926-13931 |
| HCP-BA | 1.92 | — | 27.4 | 28 (19) | — | Luo, Y.; Zhang, S.; Ma, Y.; |
| | | | | | | Wang, W.; Tan, B. |
| | | | | | | Microporous Organic |
| | | | | | | Polymers Synthesized by Self- |
| | | | | | | Condensation of Aromatic |
| | | | | | | Hydroxymethyl Monomers. |
| | | | | | | Polym Chem 2013, 4, 1126-1131 |
| HPIL-Cl- | 1.79 | 1 | 45 | 37 | — | Sang, Y.; Huang, J. |
| 2 | | | | | | Benzimidazole-Based Hyper- |
| | | | | | | Cross-Linked Poly(Ionic |
| | | | | | | Liquid)s for Efficient CO2 |
| | | | | | | Capture and Conversion. |
| | | | | | | Chem. Engin. J. 2020, 385, |
| | | | | | | 123973. |
| HCP-B | 1.46 | 1.26 | — | — | — | Huang, J.; Zhu, J.; Snyder, S. |
| | | | | | | A.; Morris, A. J.; Turner, S. |
| | | | | | | R. Nanoporous Highly |
| | | | | | | Crosslinked Polymer |
| | | | | | | Networks with Covalently |
| | | | | | | Bonded Amines for CO2 |
| | | | | | | Capture. Polymer 2018, 154, |
| | | | | | | 55-61 |
| CB-PCP- | 2.04 | 1.2 | 35 | — | — | Dani, A.; Crocellà, V.; |
| 1 | | | | | | Magistris, C.; Santoro, V.; |
| | | | | | | Yuan, J.; Bordiga, S. Click- |
| | | | | | | Based Porous Cationic |
| | | | | | | Polymers for Enhanced |
| | | | | | | Carbon Dioxide Capture. J |
| | | | | | | Mater Chem A 2017, 5 372-383 |
| TBP-1 | 1.16 | 0.79 | 33.7 | — | — | Bera, R.; Mondal, S.; Das, N. |
| | | | | | | Nanoporous Triptycene |
| | | | | | | Based Network Polyamides |
| | | | | | | (TBPs) for Selective CO2 |
| | | | | | | Uptake. Polymer 2017, 111, |
| | | | | | | 275-284 |
| STNP3 | 1.95 | 1.14 | 22 | — | — | Alam, A.; Hassan, A.; Bera, |
| | | | | | | R.; Das, N. Silsesquioxane- |
| | | | | | | Based and Triptycene-Linked |
| | | | | | | Nanoporous Polymers |
| | | | | | | (STNPs) with a High Surface |
| | | | | | | Area for CO2 Uptake and |
| | | | | | | Efficient Dye Removal |
| | | | | | | Applications. Mater Adv |
| | | | | | | 2020, 1 (9), 3406-3416 |
| HPP-3 | 1.38 | 0.68 | 35 | — | — | Wang, D.; Yang, W.; Feng, |
| | | | | | | S.; Liu, H. Constructing |
| | | | | | | Hybrid Porous Polymers |
| | | | | | | from Cubic |
| | | | | | | Octavinylsilsequioxane and |
| | | | | | | Planar Halogenated Benzene. |
| | | | | | | Polym Chem 2014, 5 3634-3642 |

TPPM's CO₂/CH₄ and CO₂/N₂ selectivity were assessed at different temperatures after achieving its intended CO₂ adsorption performance. One of the key steps in CO₂ capturing from flue gases after combustion is to separate it from N₂, which normally contains approximately 15% CO₂ and more than 70% N₂. Furthermore, as biogas and other CH₄-rich gases are frequently equimolar mixtures of CO₂ and CH₄, it is hepful to separate CO₂ from CH₄. Thus, to evaluate TPPM's potential to separate CO₂/CH₄ mixture (50% CO₂:50% CH₄) from landfill gas and CO₂/N₂ mixture (15/85, v/v) from flue gas.

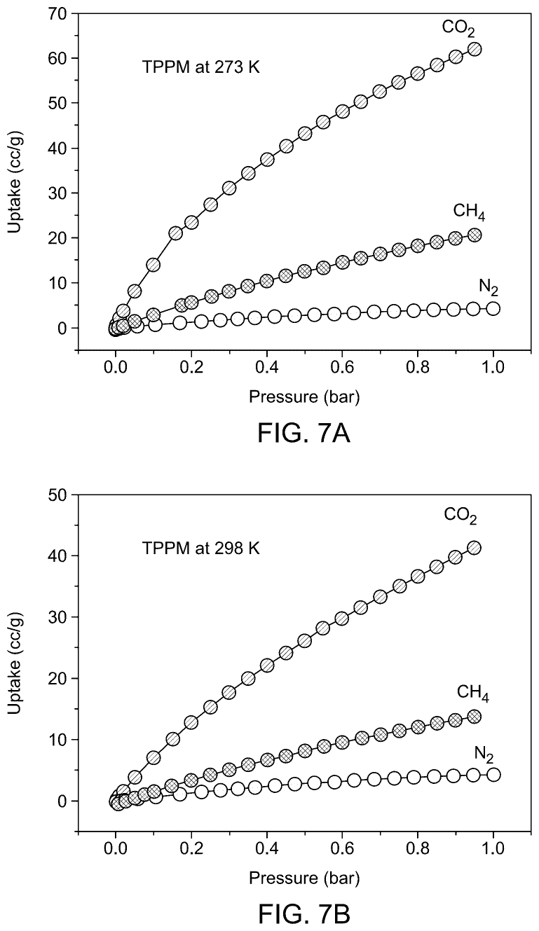

The adsorption isotherms of N₂, CH₄, and CO₂ were evaluated at 273 and 298 K temperature and 1 bar pressure to assess the selective CO₂ capture ability of TPPM, as illustrated in FIGS. 7A-7B. The results revealed that TPPM was more effective at capturing CO₂ than N₂ and CH₄. The adsorption isotherms at 273 and 298 K exhibited that CO₂ was adsorbed significantly higher than CH₄ and N₂. This indicates that TMPP has a higher CO₂ affinity than CH₄ and N₂. Notably, the CO₂ uptake of TPPM at 273 K temperature was about 15 times higher than the N₂ uptake at 1 bar pressure. This is because of the polarity difference between CO₂ and N₂, which further indicates a higher selectivity and affinity exhibited by TPPM for CO₂ over N₂.

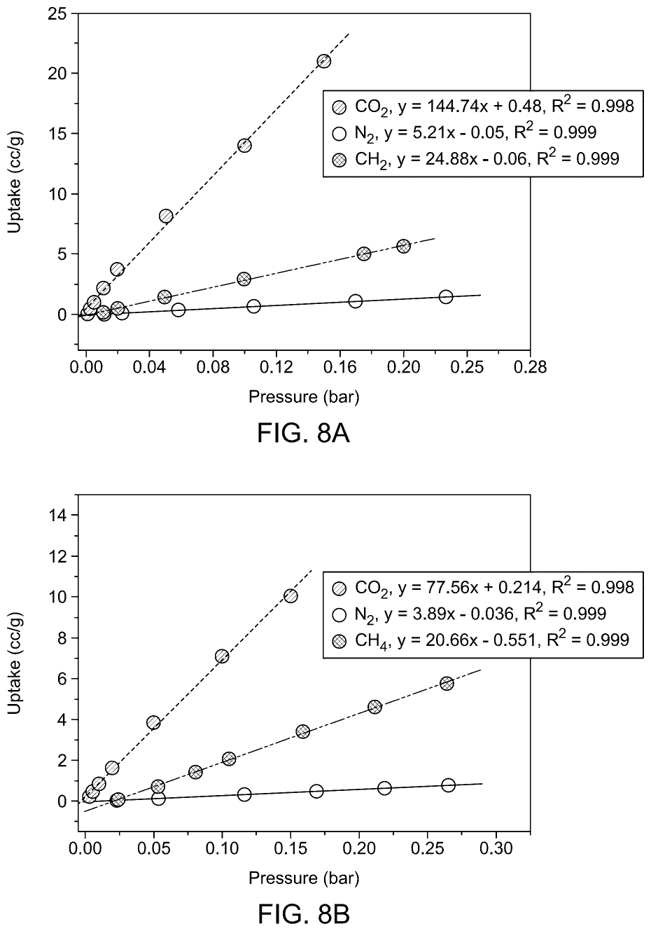

The CO₂/N₂. and CO₂/CH₄ selectivity values were measured by utilizing Henry Law's initial slope ratio method (FIGS. 8A-8B), which is used for predicting the values of selectivity for the mixture of gases from experimentally obtained single-component adsorption isotherms of adsorption in a given conditions. TPPM displayed promising CO₂/N₂ selectivity of 27.8 at 273 K and 1 bar pressure (Table 3). The observed CO₂ over N₂ selectivity is also superior or comparable to many other previously reported porous polymeric adsorbents, for example, (CTFs, 13-32) [See: Dey, S.; Bhunia, A.; Breitzke, H.; Groszewicz, P. B.; Buntkowsky, G.; Janiak, C. Two Linkers Are Better than One: Enhancing CO₂ Capture and Separation with Porous Covalent Triazine-Based Frameworks from Mixed Nitrile Linkers. J Mater Chem A 2017, 5, 3609-3620] (TBP-OH, 27.7) [See: Ansari, M.; Das, N. Triptycene-Based Porous Photoluminescent Polymers with Dual Role: Efficient Capture of Carbon Dioxide and Sensitive Detection of Picric Acid. Mater Today Chem 2022, 23, 100723] (TBHCP-OH, 23.1) [See: Ansari, M.; Hassan, A.; Alam, A.; Das, N. A Mesoporous Polymer Bearing 3D-Triptycene, —OH and Azo-Functionalities: Reversible and Efficient Capture of Carbon Dioxide and Iodine Vapor. Microporous Mesoporous Mater. 2021, 323, 111242] (HCP-0 (16.9) [See: Fu, Z.; Mohamed, I. M. A.; Li, J.; Liu, C. Novel Adsorbents Derived from Recycled Waste Polystyrene via Cross-Linking Reaction for Enhanced Adsorption Capacity and Separation Selectivity of CO 2. J Taiwan Inst Chem Eng 2019, 97, 381-388], (TBP1, 27) [See: Bera, R.; Mondal, S.; Das, N. Nanoporous Triptycene Based Network Polyamides (TBPs) for Selective CO₂ Uptake. Polymer 2017, 111, 275-284] (HCP1b, 32.8) [See: Shao, L.; Liu, N.; Wang, L.; Sang, Y.; Wan, H.; Zhan, P.; Zhang, L.; Huang, J.; Chen, J. Facile Preparation of Oxygen-Rich Porous Polymer Microspheres from Lignin-Derived Phenols for Selective CO₂ Adsorption and lodine Vapor Capture. Chemosphere 2022, 288, 132499], polyethylimine grafted porous polymer (TCP-PEI, 34) [See: Ravi, S.; Choi, Y.; Park, W.; Han, H. H.; Wu, S.; Xiao, R.; Bae, Y. S. Novel Triazine Carbonyl Polymer with Large Surface Area and Its Polyethylimine Functionalization for CO₂ Capture. J. Ind. Eng. Chem. 2022, 108, 188-194], and porous polyamides PTPA-3 (31.6) [See: Shao, L.; Liu, M.; Sang, Y.; Huang, J. One-Pot Synthesis of Melamine-Based Porous Polyamides for CO₂ Capture. Microporous Mesoporous Mater. 2019, 285. 105-111]. At 298 K, TPPM's CO₂/N₂ selectivity was estimated to be 20. The CO₂/CH₄ selectivity values were measured to be 5.8 and 3.8 at 273 and 298 K temperatures, respectively. At a given temperature the selectivity of CO₂/N₂ is relatively higher than that of CO₂/CH₄ selectivity as CO₂ and N₂ show a greater difference in polarizability as compared to CO₂ and CH₄. Further, the selectivity decreases with increasing temperature for both CO₂/N₂ and CO₂/CH₄ separation, indicating that the adsorbent shows both better capacity and selectivity at 273 K. Further, at both investigated temperatures, CO₂ capacity is the highest, followed by CH₄ and N₂ is the least adsorbed. This is attributed to the highest polarizability (2.507 cubic angstrom (Å³) vs 2.448 Å³ for CH₄ and 1.710 Å³ for N₂) and quadrupole moment (4.30 DÅ for CO₂ vs 1.54 DÅ and 0.02 DÅ for N₂ and CH₄) of CO₂ among the three gases which favors stronger physisorption interactions of CO₂ than the other two adsorbents [See: Hanif, A.; Aziz, M. A.; Helal, A.; Abdelnaby, M. M.; Qasem, M. A. A.; Khan, A.; Hakeem, A. S.; Al-Betar, A. F.; Khan, M. Y. CO2 Adsorption on Pore-Engineered Carbons Derived from Jute Sticks. Chem. Asian J. 2023, 18, e202300481]. Further, CO₂ is a weakly acidic gas and may interact with the basic N-atoms of the TPPM through weak acid-base interactions. Moreover, though N₂ has a higher quadrupole moment than CH₄, however, CH₄ has higher polarizability than N₂ which favors its adsorption over N₂. For any gas, the adsorption decreases with increasing temperature also pointing to weak physisorption interactions existing between the adsorbate and adsorbent.

In the present disclosure, the synthesis and characterization of a new robust phenanthroline and triptycene units containing microporous polymer (TPPM) are described. The incorporation of rigid phenanthroline and 3D-triptycene motifs in TPPM provides desirable attributes such as abundant microporosity, high BET-specific surface area, and enhanced thermal stability. The polymer TPPM is microporous in nature and demonstrated a high SA_{BET} of 1120 m²/g. All the aforementioned structural features in the polymer (TPPM) render it a promising material for efficient and selective CO₂ uptakes. TPPM showed a high CO₂ uptake of 2.76 mmol g⁻¹ at 273 K temperature. The CO₂/N₂ selectivity values at different temperatures were also observed to be reasonably high (20-28). Therefore, TPPM can be considered as a potentially useful material for environmental remediation applications considering its facile synthesis and capacity to efficiently and selectively capture CO₂ over N₂ and CH₄. Considering TPPM's desirable structural features this study further encourages us and others to continue investigating and synthesizing phenanthroline-incorporated porous polymers linked with other rigid and aromatic motifs to enhance the sorbent properties for useful applications.

The design, synthesis, and characterization of a novel robust microporous polymer (TPPM) with phenanthroline and triptycene units are presented. The rigid phenanthroline and 3D-triptycene motifs in TPPM confer desirable attributes such as high microporosity, large BET-specific surface area, and improved thermal stability. The TPPM polymer is microporous and exhibits a high S_{ABET} of 1120 m²/g. These structural features make TPPM a promising material for efficient and selective CO₂ capture. TPPM has a high CO₂ uptake of 2.76 mmol g⁻¹ at 273 K temperature. The CO₂/N₂ selectivity values at different temperatures are also reasonably high (20-28). Therefore, TPPM can be a potential material for environmental remediation applications due to its easy synthesis and ability to selectively and efficiently capture CO₂ over N₂ and CH4.

Numerous modifications and variations of the present disclosure are possible in light of the above teachings. Therefore, it is to be understood that within the scope of the appended claims, the invention may be practiced other than as specifically described herein.

1. A microporous polymer material, comprising:
a polymer comprising reacted units of a triptycene compound and a phenanthroline compound, wherein the polymer has a contorted polymeric structure;
wherein a molar ratio of the triptycene compound to the phenanthroline compound is in a range of 1:1 to 1:4; and
wherein, in the polymer, the triptycene compound is covalently bonded to the phenanthroline compound.

2. The microporous polymer material of claim 1, wherein the triptycene compound has a formula (I): 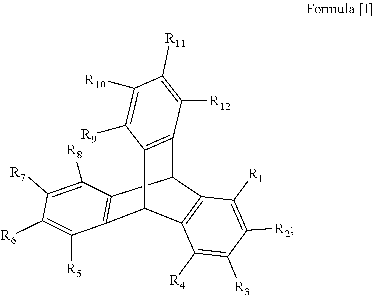
wherein R₁ to R₁₂ are each independently selected from the group consisting of a hydrogen atom, a halogen atom, an optionally substituted alkyl, an optionally substituted aryl, and an optionally substituted heterocyclic aryl.

3. The microporous polymer material of claim 2, wherein the triptycene compound is 9,10-Dihydro-9,10-[1,2]benzenoanthracene.

4. The microporous polymer material of claim 1, wherein the phenanthroline compound has a formula (II): 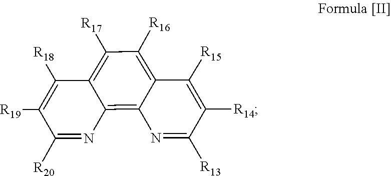
wherein R₁₃ and R₂₀ are each independently a halogen atom; and
wherein R₁₄ to R₁₉ are each independently selected from the group consisting of a hydrogen atom, a halogen atom, an optionally substituted alkyl, an optionally substituted aryl, and an optionally substituted heterocyclic aryl.

5. The microporous polymer material of claim 4, wherein the phenanthroline compound is 2,9-dichloro-1,10-phenanthroline.

6. The microporous polymer material of claim 1, wherein the reacted units have a formula (III): 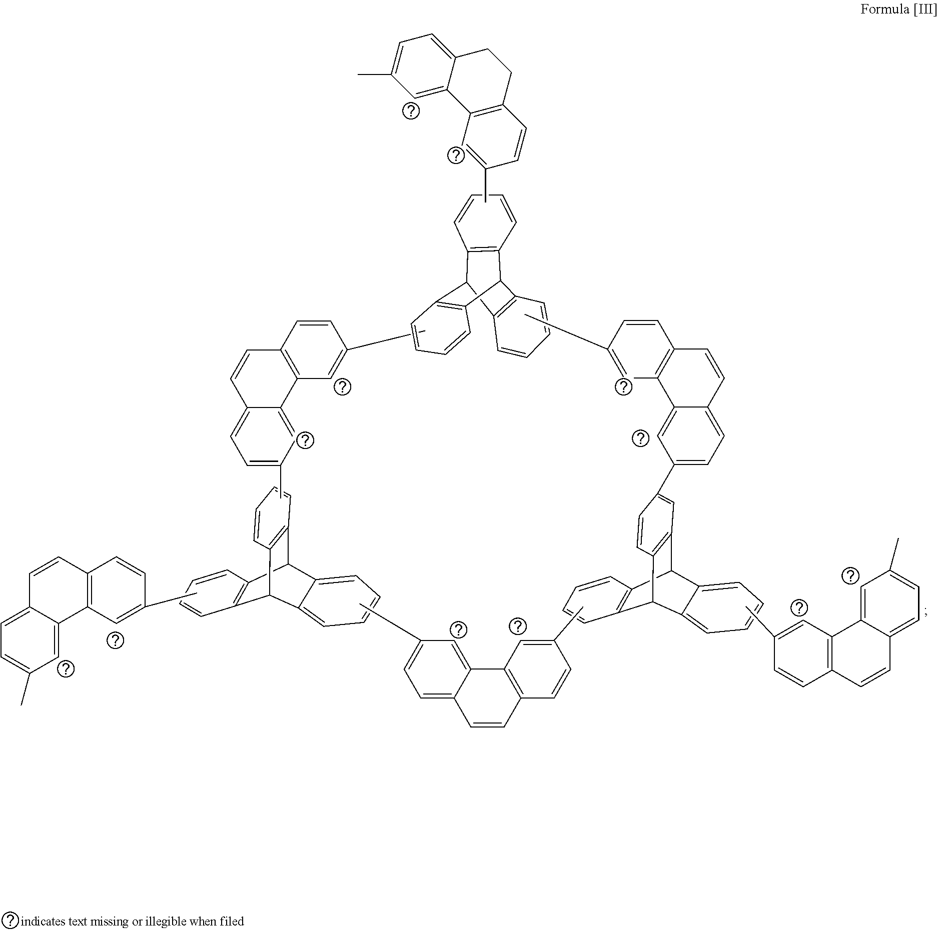
wherein [symbol] is an adjacent contorted polymeric structure.

7. The microporous polymer material of claim 1, wherein particles of the microporous polymer material are in the form of microspheres having an average diameter in a range of 0.5 to 1 micrometer (μm).

8. The microporous polymer material of claim 7, wherein the microspheres are aggregated.

9. The microporous polymer material of claim 1, having a Brunauer-Emmett-Teller (BET) surface area of 1100 to 1200 square meter per gram (m²/g).

10. The microporous polymer material of claim 1, having a total pore volume (Vₜₒₜ) of 0.6 to 0.7 cubic centimeters per gram (cm³/g).

11. The microporous polymer material of claim 1, having a micropore volume (V_{mic}) of 0.4 to 0.5 cm³/g.

12. The microporous polymer material of claim 1, having a carbon dioxide (CO₂) isosteric heat of adsorption (Qₛₜ) of 20 to 30 kilojoules per mole (KJ/mol).

13. The microporous polymer material of claim 1, having a CO₂ uptake of about 2.5 to 3 millimoles per gram (mmol/g) of the microporous polymer material at about 273 K and 1 bar.

14. The microporous polymer material of claim 1, having a CO₂ uptake of about 1.5 to 2.3 mmol/g at about 298 K and 1 bar.

15. The microporous polymer material of claim 1, having a thermal degradation temperature of 350 to 420° C., wherein the thermal degradation temperature is determined at a weight loss of 10 percent by weight based on an initial weight of the microporous polymer material.

16. A method for capturing carbon dioxide directly from a CO₂-containing gaseous composition, comprising:
contacting and passing the CO₂-containing gaseous composition through particles of the microporous polymer material of claim 1, thereby adsorbing at least a portion of CO₂ from the CO₂-containing gaseous composition onto surfaces of the microporous polymer material particles and forming a purified gas composition.

17. The method of claim 16, wherein the CO₂ is present in the CO₂-containing gaseous composition in an amount of 5 to 60 vol. % based on a total volume of the CO₂-containing gaseous composition.

18. The method of claim 16, wherein the CO₂-containing gaseous composition comprises CO₂ and N₂, and wherein the microporous polymer material has a Henry's Law selectivity for CO₂ over N₂ of about 20 to 27.8 at 270-300 K and 1 bar.

19. The method of claim 16, wherein the CO₂-containing gaseous composition comprises CO₂ and CH₄, and wherein the microporous polymer material has a Henry's Law selectivity for CO₂ over CH₄ of about 3.8 to 5.8 at 270-300 K and 1 bar.

20. The method of claim 16, further comprising:
preparing the microporous polymer material by:
mixing a triptycene compound, a phenanthroline compound, and an aluminum salt in an organic solvent to form a mixture;
wherein a molar ratio of the triptycene compound to the phenanthroline compound is in a range of 1:1 to 1:2;
wherein a molar ratio of the triptycene compound to the aluminum salt is in a range of 1:2 to 1:8;
heating and refluxing the mixture to form the microporous polymer material in the mixture; and
separating the microporous polymer material from the mixture by filtering, washing, and drying.
